(19) United States
(12) Patent Application Publication
(10) Pub. No.: US 2006/0126926 A1
(43) Pub. Date: Jun. 15, 2006

(54) Horizontal perspective representation

(76) Inventors: Michael A. Vesely, Santa Cruz, CA (US); Nancy Clemens, Santa Cruz, CA (US)

Correspondence Address: Tue Nguyen, 496 Olive Ave., Fremont, CA, 94539, US

(21) Appl. No.: 11/292,378

(22) Filed: Nov. 28, 2005

Related U.S. Application Data
(60) Provisional application No. 60/632,079, filed on Nov. 30, 2004.

(51) Int. Cl. G06K 9/00; G06T 15/00

(52) U.S. Cl. 382/154; 345/419

(57) ABSTRACT

The present invention discloses a method to represent the data into realistic, hands-on 3D images using horizontal perspective. The present invention horizontal perspective representation takes the raw data, information and knowledge and renders them into horizontal perspective 3D images. The horizontal perspective images are projected into the open space with various peripheral devices that allow the end user to manipulate the images with hands or hand-held tools. The raw data, information and knowledge can be in the form of file format, 3D file format, database, digital books including texts and pictures or drawings.

This application claims priority from U.S. provisional applications Ser. No. 60/632,079, filed on Nov. 30, 2004, entitled “Horizontal perspective representation”, which is incorporated herein by reference.

### FIELD OF INVENTION

This invention relates to a three-dimensional simulator system, and in particular, to a computer representation system using 3D horizontal perspective.

### BACKGROUND OF THE INVENTION

Three dimensional (3D) capable electronics and computing hardware devices and real-time computer-generated 3D computer graphics have been a popular area of computer science for the past few decades, with innovations in visual, audio and tactile systems.

Ever since humans began to communicate through pictures, they faced a dilemma of how to accurately represent the three-dimensional world they lived in. Sculpture was used to successfully depict three-dimensional objects, but was not adequate to communicate spatial relationships between objects and within environments. To do this, early humans attempted to “flatten” what they saw around them onto two-dimensional, vertical planes (e.g. paintings, drawings, tapestries, etc.). Scenes where a person stood upright, surrounded by trees, were rendered relatively successfully on a vertical plane. But how could they represent a landscape, where the ground extended out horizontally from where the artist was standing, as far as the eye could see?

The answer is three dimensional illusions. The two dimensional pictures must provide a numbers of cues of the third dimension to the brain to create the illusion of three dimensional images. This effect of third dimension cues can be realistically achievable due to the fact that the brain is quite accustomed to it. The three dimensional real world is always and already converted into two dimensional (e.g. height and width) projected image at the retina, a concave surface at the back of the eye. And from this two dimensional image, the brain, through experience and perception, generates the depth information to form the three dimension visual image from two types of depth cues: monocular (one eye perception) and binocular (two eye perception). In general, binocular depth cues are innate and biological while monocular depth cues are learned and environmental.

In binocular depth cues, the disparity of the retinal images due to the separation of the two eyes is used to create the perception of depth. The effect is called stereoscopy where each eye receives a slightly different view of a scene, and the brain fuses them together using these differences to determine the ratio of distances between nearby objects. There are also depth cues with only one eye, called monocular depth cues, to create an impression of depth on a flat image.

Perspective drawing, together with relative size, is most often used to achieve the illusion of three dimension depth and spatial relationships on a flat (two dimension) surface, such as paper or canvas. Through perspective, three dimension objects are depicted on a two dimension plane, but “trick” the eye into appearing to be in three dimension space. Some perspective examples are military, cavalier, isometric, and dimetric, as shown at the top of FIG. 1.

Of special interest is the most common type of perspective, called central perspective, shown at the bottom left of FIG. 1. Central perspective, also called one-point perspective, is the simplest kind of “genuine” perspective construction, and is often taught in art and drafting classes for beginners. FIG. 2 further illustrates central perspective. Using central perspective, the chess board and chess pieces look like three dimension objects, even though they are drawn on a two dimensional flat piece of paper. Central perspective has a central vanishing point, and rectangular objects are placed so their front sides are parallel to the picture plane. The depth of the objects is perpendicular to the picture plane. All parallel receding edges run towards a central vanishing point. The viewer looks towards this vanishing point with a straight view. When an architect or artist creates a drawing using central perspective, they must use a single-eye view. That is, the artist creating the drawing captures the image by looking through only one eye, which is perpendicular to the drawing surface.

The vast majority of images, including central perspective images, are displayed, viewed and captured in a plane perpendicular to the line of vision. Viewing the images at angle different from 90° would result in image distortion, meaning a square would be seen as a rectangle when the viewing surface is not perpendicular to the line of vision.

Central perspective is employed extensively in 3D computer graphics, for a myriad of applications, such as scientific, data visualization, computer-generated prototyping, special effects for movies, medical imaging, and architecture, to name just a few.

FIG. 3 illustrates a view volume in central perspective to render computer-generated 3D objects to a computer monitor's vertical, 2D viewing surface. In FIG. 3, a near clip plane is the 2D plane onto which the x, y, z coordinates of the 3D objects within the view volume will be rendered. Each projection line starts at the camera point, and ends at a x, y, z coordinate point of a virtual 3D object within the view volume.

The basic of prior art 3D computer graphics is the central perspective projection. 3D central perspective projection, though offering realistic 3D illusion, has some limitations is allowing the user to have hands-on interaction with the 3D display.

There is a little known class of images that we called it “horizontal perspective” where the image appears distorted when viewing head on, but displaying a three dimensional illusion when viewing from the correct viewing position. In horizontal perspective, the angle between the viewing surface and the line of vision is preferably 45° but can be almost any angle, and the viewing surface is preferably horizontal (wherein the name “horizontal perspective”), but it can be any surface, as long as the line of vision forming a not-perpendicular angle to it.

Horizontal perspective images offer realistic three dimensional illusion, but are little known primarily due to the narrow viewing location (the viewer's eyepoint has to be coincide precisely with the image projection eyepoint), and the complexity involving in projecting the two dimensional image or the three dimension model into the horizontal perspective image.

The generation of horizontal perspective images requires considerably more expertise to create than conventional perpendicular images. The conventional perpendicular images can be produced directly from the viewer or camera point. One need simply open one's eyes or point the camera in any direction to obtain the images. Further, with much experience in viewing three dimensional depth cues from perpendicular images, viewers can tolerate significant amount of distortion generated by the deviations from the camera point. In contrast, the creation of a horizontal perspective image does require much manipulation. Conventional camera, by projecting the image into the plane perpendicular to the line of sight, would not produce a horizontal perspective image. Making a horizontal drawing requires much effort and very time consuming. Further, since human has limited experience with horizontal perspective images, the viewer's eye must be positioned precisely where the projection eyepoint point is to avoid image distortion. And therefore horizontal perspective, with its difficulties, has received little attention.

The present invention recognizes that the personal computer is perfectly suitable for horizontal perspective display. It is personal, thus it is designed for the operation of one person, and the computer, with its powerful microprocessor, is well capable of rendering various horizontal perspective images to the viewer. Further, horizontal perspective offers open space display of 3D images, thus allowing the hand-on interaction of the end users.

### SUMMARY OF THE INVENTION

Thus the present invention discloses a method to represent the data into realistic, hand-on 3D images using horizontal perspective. The present invention horizontal perspective representation takes the raw data, information and knowledge and renders them into horizontal perspective 3D images. The horizontal perspective images are projected into the open space with various peripheral devices that allow the end user to manipulate the images with hands or hand-held tools. The raw data, information and knowledge can be in the form of file format, 3D file format, database, digital books including texts and pictures or drawings.

The data is stored in a file, preferably using a 3D file format so that the 3D images can be represented by horizontal perspective when needed. The data can be scanned pictures, 3D scanned objects, and multi-view scanned images to render left and right views to form horizontal perspective images.

For example, the present invention horizontal perspective representation can be used in a doctor office. When a patient is examined, the doctor can call up the patient's name from the computer system, and the computer system displays a 3D horizontal perspective image of the patient. The image is taken from the patient earlier and stored in 3D file format in the computer. This is similar to the selection of the patient's name and having a 2D picture of the patient displaying. The different is the 3D horizontal perspective images, allowing the doctor to interact with the image through hand-on simulations. Horizontal perspective images provide realistic 3D images while allow the viewer to interact or virtually touch all portions of the images.

The data can further be stored in a database. The data can be a complete data, or can share a portion with the main section of the database. For example, the patient's representation by 3D horizontal perspective can be a generic image with generic face and generic body. The specific patient data can then be inserted into the horizontal perspective representation, such as the patient name, sex, or any relevant information for the case at hand.

The data can be measured data, for example, data from a MRI scan, brain scan, DNA measures, cell structure measures. These data can be stored in a database under the patient. Thus when the doctor chooses the patient's name, and elects to see the particular aspect of the situation, the database can be available to present the information. For example, if the patient suffers a broken bone, the doctor can call the MRI scan data from the database and represention can zoom in the section selected, in this case, the broken bone. The broken bone is showing in 3D horizontal perspective, with zoom and rotation capability and even layer stripping capability to allow realistic viewing of the current situation. The representation is possible due to the available data stored in the database. If the data is not available, the 3D representation will be just a generic space-holder image. That signifies that the data is not available and if needed, the test should be ordered and the data collected.

With zooming capability, the doctor can start with the patient body, and then zoom to the particular section. For example, if the patient has a broken bone in the foot, the zoom could show the section of that bone. The showing is made possible with the data taken earlier from the patient foot, such as an x-ray test.

Further zooming is also possible, to the cell level and even DNA level for genetic evaluation. The present invention horizontal perspective representation takes the data in various formats, such as x-ray data, MRI data, NDA data, cell data, and put together to show a realistic 3D image of the data. This will allow the fast viewing and adsorption of knowledge and quick evaluation and analysis and diagnotic of the case. A major advantage of the present invention is the convertion of the number or bits and bytes from the data ar database and represent them in 3D image where the interpretation can be made easier.

Furthermore, the 3D representation can gather data from books to compare the current case with the text book learning. The doctor can call on book written on the subject and show with 3D horizontal perspective. The knowledge transferred from book to 3D horizontal perspective can make the learning and evaluation quicker and easier. If books are not enough, email or phone or visit with an expert can also be made and the images transferred by horizontal perspective.

The representation by 3D horizontal perspective from the data collected in a file, a database, or a book can accelerate the learning capability. Horizontal perspective representation can be a superior way to display raw data, information and knowledge.

### BRIEF DESCRIPTION OF THE DRAWINGS

FIG. 1 shows the various perspective drawings.

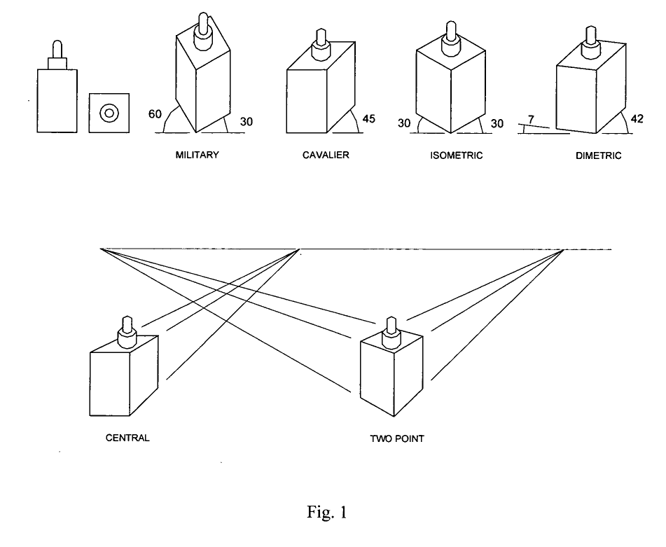

FIG. 2 shows a typical central perspective drawing.

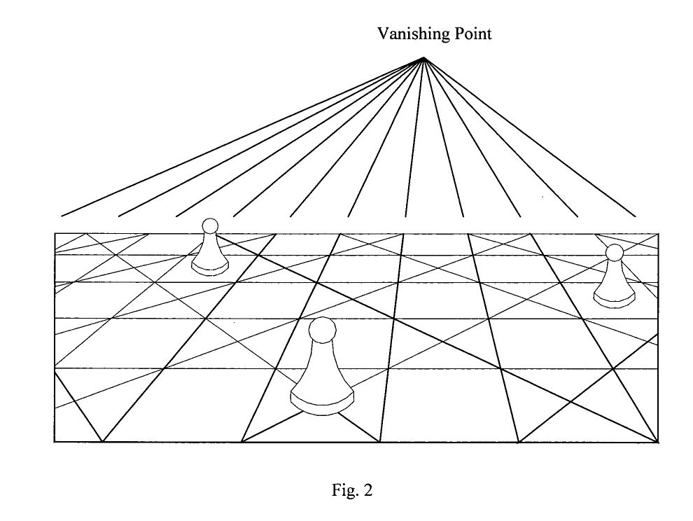

FIG. 3 illustrates a central perspective camera model.

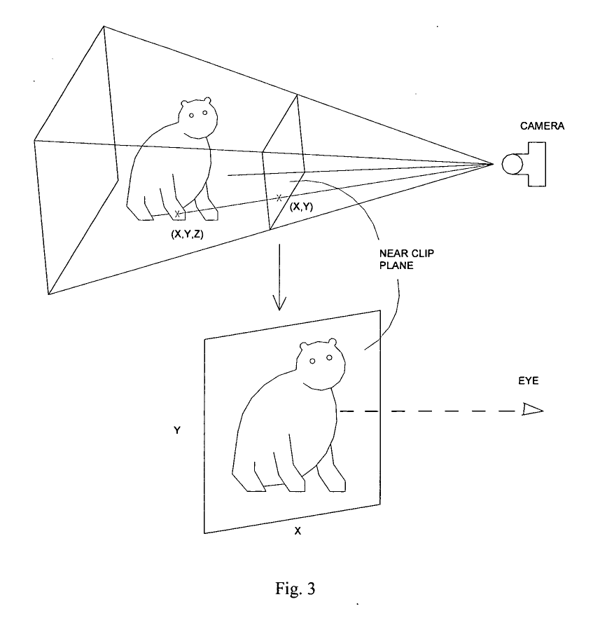

FIG. 4 shows the comparison of central perspective (Image A) and horizontal perspective (Image B).

FIG. 5 shows the central perspective drawing of three stacking blocks.

FIG. 6 shows the horizontal perspective drawing of three stacking blocks.

FIG. 7 shows the method of drawing a horizontal perspective drawing.

FIG. 8 shows mapping of the 3D object onto the horizontal plane.

FIG. 9 shows mapping of the 3D object onto the horizontal plane.

FIG. 10 shows the two-eye view of 3D simulation.

FIG. 11 shows the various 3D peripherals.

FIG. 12 shows the computer interacting in 3D simulation environment.

FIG. 13 shows the computer tracking in 3D simulation environment.

FIG. 14 shows the mapping of virtual attachments to end of tools.

### DETAILED DESCRIPTION OF THE INVENTION

The disclosed invention takes the data, information and knowledge and represents them in 3D horizontal perspective. More specifically, these new inventions enable real-time computer-generated 3D simulations representation of other real-world physical knowledge. The present invention horizontal perspective representation is build upon the horizontal perspective system capable of projecting three dimensional illusions based on horizontal perspective projection.

Horizontal perspective is a little-known perspective, of which we found only two books that describe its mechanics: Stereoscopic Drawing (©1990) and How to Make Anaglyphs (©1979, out of print). Although these books describe this obscure perspective, they do not agree on its name. The first book refers to it as a “free-standing anaglyph,” and the second, a “phantogram.” Another publication called it “projective anaglyph” (U.S. Pat. No. 5,795,154 by G. M. Woods, Aug. 18, 1998). Since there is no agreed-upon name, we have taken the liberty of calling it “horizontal perspective.” Normally, as in central perspective, the plane of vision, at right angle to the line of sight, is also the projected plane of the picture, and depth cues are used to give the illusion of depth to this flat image. In horizontal perspective, the plane of vision remains the same, but the projected image is not on this plane. It is on a plane angled to the plane of vision. Typically, the image would be on the ground level surface. This means the image will be physically in the third dimension relative to the plane of vision. Thus horizontal perspective can be called horizontal projection.

In horizontal perspective, the object is to separate the image from the paper, and fuse the image to the three dimension object that projects the horizontal perspective image. Thus the horizontal perspective image must be distorted so that the visual image fuses to form the free standing three dimensional figure. It is also essential the image is viewed from the correct eye points, otherwise the three dimensional illusion is lost. In contrast to central perspective images which have height and width, and project an illusion of depth, and therefore the objects are usually abruptly projected and the images appear to be in layers, the horizontal perspective images have actual depth and width, and illusion gives them height, and therefore there is usually a graduated shifting so the images appear to be continuous.

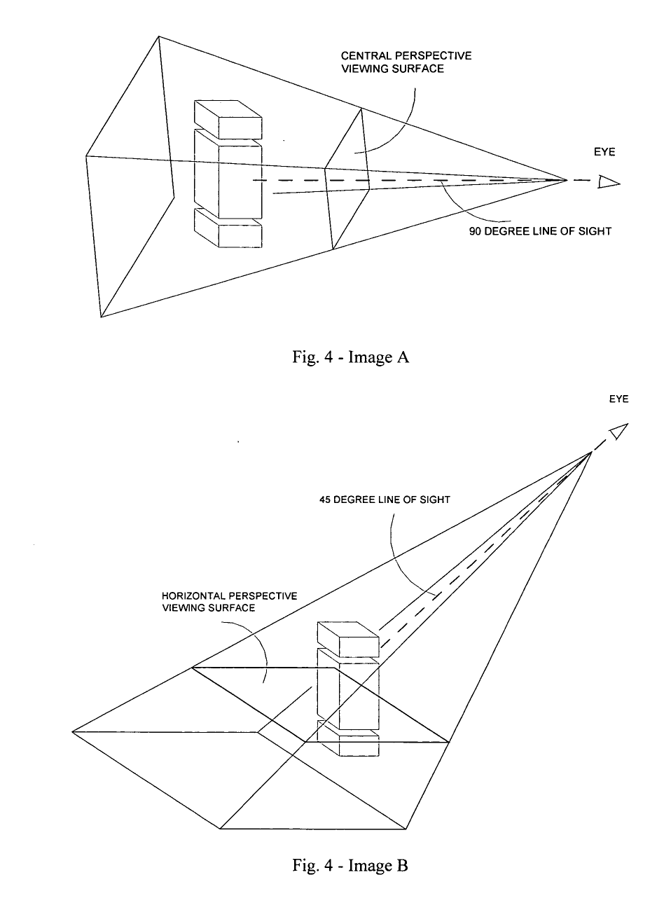

FIG. 4 compares key characteristics that differentiate central perspective and horizontal perspective. Image A shows key pertinent characteristics of central perspective, and Image B shows key pertinent characteristics of horizontal perspective.

In other words, in Image A, the real-life three dimension object (three blocks stacked slightly above each other) was drawn by the artist closing one eye, and viewing along a line of sight perpendicular to the vertical drawing plane. The resulting image, when viewed vertically, straight on, and through one eye, looks the same as the original image.

In Image B, the real-life three dimension object was drawn by the artist closing one eye, and viewing along a line of sight 45° to the horizontal drawing plane. The resulting image, when viewed horizontally, at 45° and through one eye, looks the same as the original image.

One major difference between central perspective showing in Image A and horizontal perspective showing in Image B is the location of the display plane with respect to the projected three dimensional image. In horizontal perspective of Image B, the display plane can be adjusted up and down, and therefore the projected image can be displayed in the open air above the display plane, i.e. a physical hand can touch (or more likely pass through) the illusion, or it can be displayed under the display plane, i.e. one cannot touch the illusion because the display plane physically blocks the hand. This is the nature of horizontal perspective, and as long as the camera eyepoint and the viewer eyepoint is at the same place, the illusion is present. In contrast, in central perspective of Image A, the three dimensional illusion is likely to be only inside the display plane, meaning one cannot touch it. To bring the three dimensional illusion outside of the display plane to allow viewer to touch it, the central perspective would need elaborate display scheme such as surround image projection and large volume.

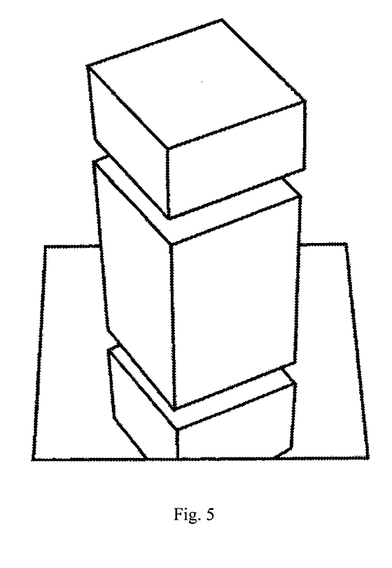

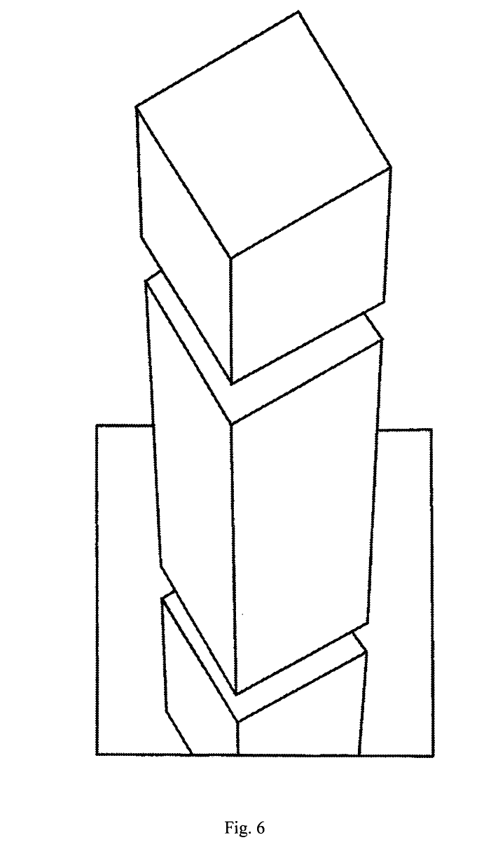

FIGS. 5 and 6 illustrate the visual difference between using central and horizontal perspective. To experience this visual difference, first look at FIG. 5, drawn with central perspective, through one open eye. Hold the piece of paper vertically in front of you, as you would a traditional drawing, perpendicular to your eye. You can see that central perspective provides a good representation of three dimension objects on a two dimension surface.

Now look at FIG. 6, drawn using horizontal perspective, by sifting at your desk and placing the paper lying flat (horizontally) on the desk in front of you. Again, view the image through only one eye. This puts your one open eye, called the eye point at approximately a 45° angle to the paper, which is the angle that the artist used to make the drawing. To get your open eye and its line-of-sight to coincide with the artist's, move your eye downward and forward closer to the drawing, about six inches out and down and at a 45° angle. This will result in the ideal viewing experience where the top and middle blocks will appear above the paper in open space.

Again, the reason your one open eye needs to be at this precise location is because both central and horizontal perspective not only defines the angle of the line of sight from the eye point; they also define the distance from the eye point to the drawing. This means that FIGS. 5 and 6 are drawn with an ideal location and direction for your open eye relative to the drawing surfaces. However, unlike central perspective where deviations from position and direction of the eye point create little distortion, when viewing a horizontal perspective drawing, the use of only one eye and the position and direction of that eye relative to the viewing surface are essential to seeing the open space three dimension horizontal perspective illusion.

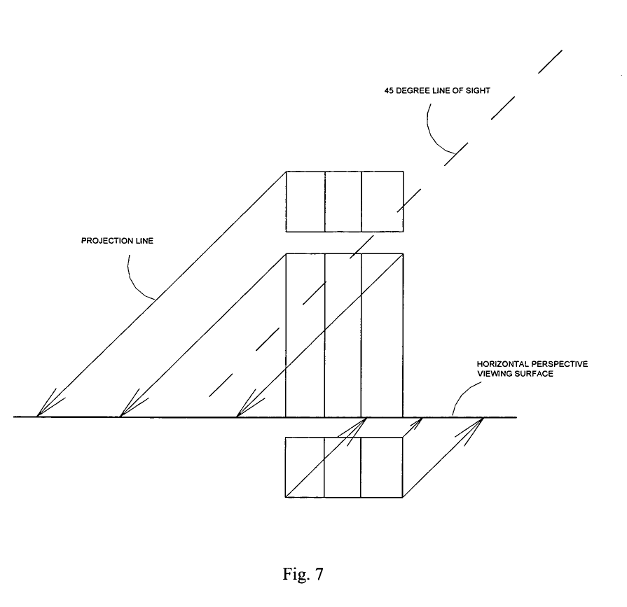

FIG. 7 is an architectural-style illustration that demonstrates a method for making simple geometric drawings on paper or canvas utilizing horizontal perspective. FIG. 7 is a side view of the same three blocks used in FIG. 6. It illustrates the actual mechanics of horizontal perspective. Each point that makes up the object is drawn by projecting the point onto the horizontal drawing plane. To illustrate this, FIG. 7 shows a few of the coordinates of the blocks being drawn on the horizontal drawing plane through projection lines. These projection lines start at the eye point (not shown in FIG. 7 due to scale), intersect a point on the object, then continue in a straight line to where they intersect the horizontal drawing plane, which is where they are physically drawn as a single dot on the paper. When an architect repeats this process for each and every point on the blocks, as seen from the drawing surface to the eye point along the line-of-sight the horizontal perspective drawing is complete, and looks like FIG. 6.

Notice that in FIG. 7, one of the three blocks appears below the horizontal drawing plane. With horizontal perspective, points located below the drawing surface are also drawn onto the horizontal drawing plane, as seen from the eye point along the line-of-site. Therefore when the final drawing is viewed, objects not only appear above the horizontal drawing plane, but may also appear below it as well—giving the appearance that they are receding into the paper. If you look again at FIG. 6, you will notice that the bottom box appears to be below, or go into, the paper, while the other two boxes appear above the paper in open space.

The generation of horizontal perspective images requires considerably more expertise to create than central perspective images. Even though both methods seek to provide the viewer the three dimension illusion that resulted from the two dimensional image, central perspective images produce directly the three dimensional landscape from the viewer or camera point. In contrast, the horizontal perspective image appears distorted when viewing head on, but this distortion has to be precisely rendered so that when viewing at a precise location, the horizontal perspective produces a three dimensional illusion.

The horizontal perspective display system promotes horizontal perspective projection viewing by providing the viewer with the means to adjust the displayed images to maximize the illusion viewing experience. By employing the computation power of the microprocessor and a real time display, the horizontal perspective display, comprising a real time electronic display capable of re-drawing the projected image, together with a viewer's input device to adjust the horizontal perspective image. By re-display the horizontal perspective image so that its projection eyepoint coincides with the eyepoint of the viewer, the horizontal perspective display of the present invention can ensure the minimum distortion in rendering the three dimension illusion from the horizontal perspective method. The input device can be manually operated where the viewer manually inputs his or her eyepoint location, or change the projection image eyepoint to obtain the optimum three dimensional illusions. The input device can also be automatically operated where the display automatically tracks the viewer's eyepoint and adjust the projection image accordingly. The horizontal perspective display system removes the constraint that the viewers keeping their heads in relatively fixed positions, a constraint that create much difficulty in the acceptance of precise eyepoint location such as horizontal perspective or hologram display.

The horizontal perspective display system can further a computation device in addition to the real time electronic display device and projection image input device providing input to the computational device to calculating the projectional images for display to providing a realistic, minimum distortion three dimensional illusion to the viewer by coincide the viewer's eyepoint with the projection image eyepoint. The system can further comprise an image enlargement/reduction input device, or an image rotation input device, or an image movement device to allow the viewer to adjust the view of the projection images.

The input device can be operated manually or automatically. The input device can detect the position and orientation of the viewer eyepoint, to compute and to project the image onto the display according to the detection result. Alternatively, the input device can be made to detect the position and orientation of the viewer's head along with the orientation of the eyeballs. The input device can comprise an infrared detection system to detect the position the viewer's head to allow the viewer freedom of head movement. Other embodiments of the input device can be the triangulation method of detecting the viewer eyepoint location, such as a CCD camera providing position data suitable for the head tracking objectives of the invention. The input device can be manually operated by the viewer, such as a keyboard, mouse, trackball, joystick, or the like, to indicate the correct display of the horizontal perspective display images.

The horizontal perspective image projection employs the open space characteristics, and thus enables an end user to interact physically and directly with real-time computer-generated 3D graphics, which appear in open space above the viewing surface of a display device, i.e. in the end user's own physical space.

In horizontal perspective, the computer hardware viewing surface is preferably situated horizontally, such that the end-user's line of sight is at a 45° angle to the surface. Typically, this means that the end user is standing or seated vertically, and the viewing surface is horizontal to the ground. Note that although the end user can experience hands-on simulations at viewing angles other than 45° (e.g. 55°, 30° etc.), it is the optimal angle for the brain to recognize the maximum amount of spatial information in an open space image. Therefore, for simplicity's sake, we use “45°” throughout this document to mean “an approximate 45 degree angle”. Further, while horizontal viewing surface is preferred since it simulates viewers' experience with the horizontal ground, any viewing surface could offer similar three dimensional illusion experience. The horizontal perspective illusion can appear to be hanging from a ceiling by projecting the horizontal perspective images onto a ceiling surface, or appear to be floating from a wall by projecting the horizontal perspective images onto a vertical wall surface.

The horizontal perspective display creates a “Hands-On Volume” and a “Inner-Access Volume.” The Hands-On Volume is situated on and above the physical viewing surface. Thus the end user can directly, physically manipulate simulations because they co-inhabit the end-user's own physical space. This 1:1 correspondence allows accurate and tangible physical interaction by touching and manipulating simulations with hands or hand-held tools. The Inner-Access Volume is located underneath the viewing surface and simulations within this volume appear inside the physically viewing device. Thus simulations generated within the Inner-Access Volume do not share the same physical space with the end user and the images therefore cannot be directly, physically manipulated by hands or hand-held tools. That is, they are manipulated indirectly via a computer mouse or a joystick.

One major difference between the present invention and prior art graphics engine is the projection display. Existing 3D-graphics engine uses central-perspective and therefore a vertical plane to render its view volume while in the present invention simulator, a “horizontal” oriented rendering plane vs. a “vertical” oriented rendering plane is required to generate horizontal perspective open space images. The horizontal perspective images offer much superior open space access than central perspective images.

To accomplish the Hands-On Volume simulation, a synchronization is requires between the computer-generated world and their physical real-world equivalents. Among other things, this synchronization insures that images are properly displayed, preferably through a Reference Plane calibration.

A computer monitor or viewing device is made of many physical layers, individually and together having thickness or depth. For example, a typical CRT-type viewing device would include a the top layer of the monitor's glass surface (the physical “View Surface”), and the phosphor layer (the physical “Image Layer”), where images are made. The View Surface and the Image Layer are separate physical layers located at different depths or z coordinates along the viewing device's z axis. To display an image the CRT's electron gun excites the phosphors, which in turn emit photons. This means that when you view an image on a CRT, you are looking along its z axis through its glass surface, like you would a window, and seeing the light of the image coming from its phosphors behind the glass. Thus without a correction, the physical world and the computer simulation are shifted by this glass thickness.

An Angled Camera point is a point initially located at an arbitrary distance from the displayed and the camera's line-of-site is oriented at a 45° angle looking through the center. The position of the Angled Camera in relation to the end-user's eye is critical to generating simulations that appear in open space on and above the surface of the viewing device.

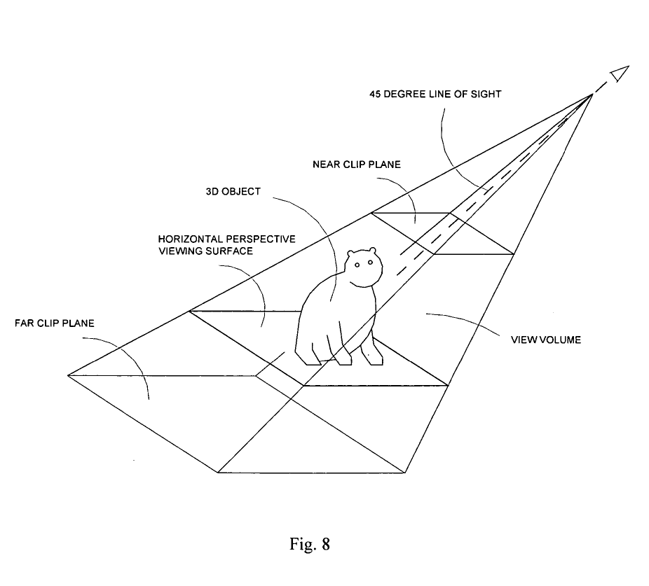

Mathematically, the computer-generated x, y, z coordinates of the Angled Camera point form the vertex of an infinite “pyramid”, whose sides pass through the x, y, z coordinates of the Reference/Horizontal Plane. FIG. 8 illustrates this infinite pyramid, which begins at the Angled Camera point and extending through the Far Clip Plane.

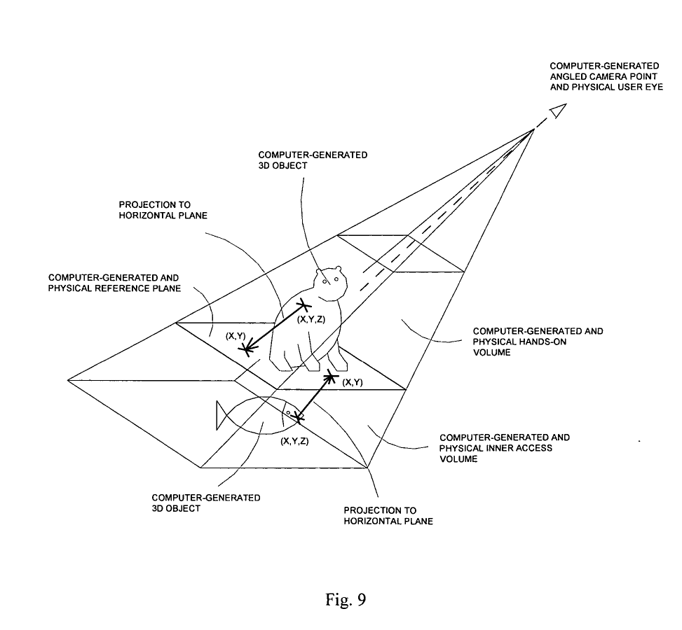

As a projection line in either the Hands-On and Inner-Access Volume intersects both an object point and the offset Horizontal Plane, the three dimensional x, y, z point of the object becomes a two-dimensional x, y point of the Horizontal Plane (see FIG. 9). Projection lines often intersect more than one 3D object coordinate, but only one object x, y, z coordinate along a given projection line can become a Horizontal Plane x, y point. The formula to determine which object coordinate becomes a point on the Horizontal Plane is different for each volume. For the Hands-On Volume it is the object coordinate of a given projection line that is farthest from the Horizontal Plane. For the Inner-Access Volume it is the object coordinate of a given projection line that is closest to the Horizontal Plane. In case of a tie, i.e. if a 3D object point from each volume occupies the same 2D point of the Horizontal Plane, the Hands-On Volume's 3D object point is used.

The hands-on simulator also allows the viewer to move around the three dimensional display and yet suffer no great distortion since the display can track the viewer eyepoint and re-display the images correspondingly, in contrast to the conventional prior art three dimensional image display where it would be projected and computed as seen from a singular viewing point, and thus any movement by the viewer away from the intended viewing point in space would cause gross distortion.

The display system can further comprise a computer capable of re-calculate the projected image given the movement of the eyepoint location. The horizontal perspective images can be very complex, tedious to create, or created in ways that are not natural for artists or cameras, and therefore require the use of a computer system for the tasks. To display a three-dimensional image of an object with complex surfaces or to create animation sequences would demand a lot of computational power and time, and therefore it is a task well suited to the computer. Three dimensional capable electronics and computing hardware devices and real-time computer-generated three dimensional computer graphics have advanced significantly recently with marked innovations in visual, audio and tactile systems, and have producing excellent hardware and software products to generate realism and more natural computer-human interfaces.

The horizontal perspective display system are not only in demand for entertainment media such as televisions, movies, and video games but are also needed from various fields such as education (displaying three-dimensional structures), technological training (displaying three-dimensional equipment). There is an increasing demand for three-dimensional image displays, which can be viewed from various angles to enable observation of real objects using object-like images. The horizontal perspective display system is also capable of substitute a computer-generated reality for the viewer observation. The systems may include audio, visual, motion and inputs from the user in order to create a complete experience of three dimensional illusions.

The input for the horizontal perspective system can be two dimensional image, several images combined to form one single three dimensional image, or three dimensional model. The three dimensional image or model conveys much more information than that a two dimensional image and by changing viewing angle, the viewer will get the impression of seeing the same object from different perspectives continuously.

The horizontal perspective display can further provide multiple views or “Multi-View” capability. Multi-View provides the viewer with multiple and/or separate left-and right-eye views of the same simulation. Multi-View capability is a significant visual and interactive improvement over the single eye view. In Multi-View mode, both the left eye and right eye images are fused by the viewer's brain into a single, three-dimensional illusion. The problem of the discrepancy between accommodation and convergence of eyes, inherent in stereoscopic images, leading to the viewer's eye fatigue with large discrepancy, can be reduced with the horizontal perspective display, especially for motion images, since the position of the viewer's gaze point changes when the display scene changes.

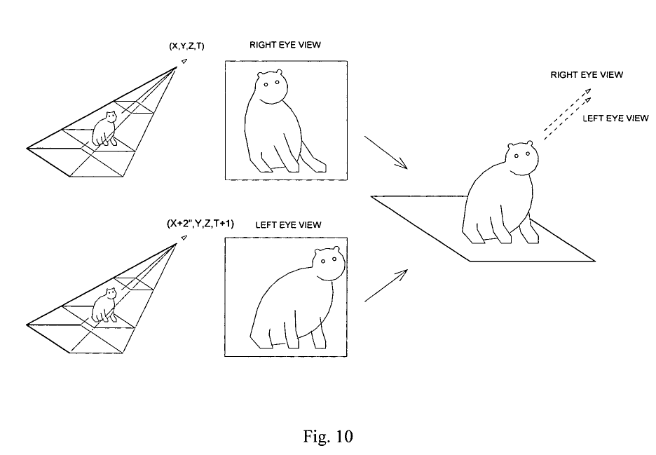

FIG. 10 helps illustrate these two stereoscopic and time simulations. The computer-generated person has both eyes open, a requirement for stereoscopic 3D viewing, and therefore sees the bear cub from two separate vantage points, i.e. from both a right-eye view and a left-eye view. These two separate views are slightly different and offset because the average person's eyes are about 2 inches apart. Therefore, each eye sees the world from a separate point in space and the brain puts them together to make a whole image. There are existing stereoscopic 3D viewing devices that require more than a separate left- and right-eye view. But because the method described here can generate multiple views it works for these devices as well.

The distances between people's eyes vary but in the above example we are using the average of 2 inches. It is also possible for the end user to provide their personal eye separation value. This would make the x value for the left and right eyes highly accurate for a given end user and thereby improve the quality of their stereoscopic 3D view.

In Multi-View mode, the objective is to simulate the actions of the two eyes to create the perception of depth, namely the left eye and the right eye sees slightly different images. Thus Multi-View devices that can be used in the present invention include methods with glasses such as anaglyph method, special polarized glasses or shutter glasses, methods without using glasses such as a parallax stereogram, a lenticular method, and mirror method (concave and convex lens).

In anaglyph method, a display image for the right eye and a display image for the left eye are respectively superimpose-displayed in two colors, e.g., red and blue, and observation images for the right and left eyes are separated using color filters, thus allowing a viewer to recognize a stereoscopic image. The images are displayed using horizontal perspective technique with the viewer looking down at an angle. As with one eye horizontal perspective method, the eyepoint of the projected images has to be coincide with the eyepoint of the viewer, and therefore the viewer input device is essential in allowing the viewer to observe the three dimensional horizontal perspective illusion. From the early days of the anaglyph method, there are much improvements such as the spectrum of the red/blue glasses and display to generate much more realism and comfort to the viewers.

In polarized glasses method, the left eye image and the right eye image are separated by the use of mutually extinguishing polarizing filters such as orthogonally linear polarizer, circular polarizer, elliptical polarizer. The images are normally projected onto screens with polarizing filters and the viewer is then provided with corresponding polarized glasses. The left and right eye images appear on the screen at the same time, but only the left eye polarized light is transmitted through the left eye lens of the eyeglasses and only the right eye polarized light is transmitted through the right eye lens.

Another way for stereoscopic display is the image sequential system. In such a system, the images are displayed sequentially between left eye and right eye images rather than superimposing them upon one another, and the viewer's lenses are synchronized with the screen display to allow the left eye to see only when the left image is displayed, and the right eye to see only when the right image is displayed. The shuttering of the glasses can be achieved by mechanical shuttering or with liquid crystal electronic shuttering. In shuttering glass method, display images for the right and left eyes are alternately displayed on a CRT in a time sharing manner, and observation images for the right and left eyes are separated using time sharing shutter glasses which are opened/closed in a time sharing manner in synchronism with the display images, thus allowing an observer to recognize a stereoscopic image.

Other way to display stereoscopic images is by optical method. In this method, display images for the right and left eyes, which are separately displayed on a viewer using optical means such as prisms, mirror, lens, and the like, are superimpose-displayed as observation images in front of an observer, thus allowing the observer to recognize a stereoscopic image. Large convex or concave lenses can also be used where two image projectors, projecting left eye and right eye images, are providing focus to the viewer's left and right eye respectively. A variation of the optical method is the lenticular method where the images form on cylindrical lens elements or two dimensional array of lens elements.

Depending on the stereoscopic 3D viewing device used, the horizontal perspective display continues to display the left- and right-eye images, as described above, until it needs to move to the next display time period. An example of when this may occur is if the bear cub moves his paw or any part of his body. Then a new and second simulated image would be required to show the bear cub in its new position. This process of generating multiple views via the nonstop incrementing of display time continues as long as the horizontal perspective display is generating real-time simulations in stereoscopic 3D.

By rapidly display the horizontal perspective images, three dimensional illusion of motion can be realized. Typically, 30 to 60 images per second would be adequate for the eye to perceive motion. For stereoscopy, the same display rate is needed for superimposed images, and twice that amount would be needed for time sequential method.

The display rate is the number of images per second that the display uses to completely generate and display one image. This is similar to a movie projector where 24 times a second it displays an image. Therefore, 1/24 of a second is required for one image to be displayed by the projector. But the display time could be a variable, meaning that depending on the complexity of the view volumes it could take 1/120, 1/12 or ½ a second for the computer to complete just one display image. Since the display was generating a separate left and right eye view of the same image, the total display time is twice the display time for one eye image.

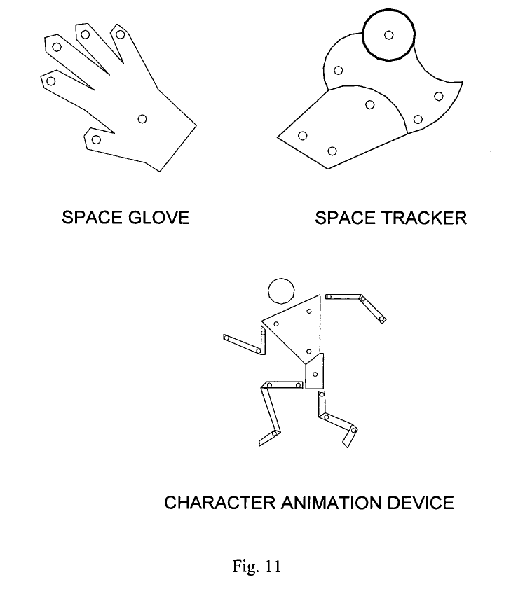

The system further includes technologies employed in computer “peripherals”. FIG. 11 shows examples of such peripherals with six degrees of freedom, meaning that their coordinate system enables them to interact at any given point in an (x, y, z) space. The examples of such peripherals are Space Glove, Space Tracker, or Character Animation Device.

Some peripherals provide a mechanism that enables the simulation to perform this calibration without any end-user involvement. But if calibrating the peripheral requires external intervention than the end-user will accomplish this through a calibration procedure. Once the peripheral is calibrated, the simulation will continuously track and map the peripheral.

With the peripherals linking to the simulator, the user can interact with the display model. The simulation can get the inputs from the user through the peripherals, and manipulate the desired action. With the peripherals properly matched with the physical space and the display space, the simulator can provide proper interaction and display. The peripheral tracking can be done through camera triangulation or through infrared tracking devices.

The simulator can further include 3D audio devices. Object Recognition is a technology that uses cameras and/or other sensors to locate simulations by a method called triangulation. Triangulation is a process employing trigonometry, sensors, and frequencies to “receive” data from simulations in order to determine their precise location in space. It is for this reason that triangulation is a mainstay of the cartography and surveying industries where the sensors and frequencies they use include but are not limited to cameras, lasers, radar, and microwave. 3D Audio also uses triangulation but in the opposite way 3D Audio “sends” or projects data in the form of sound to a specific location. But whether you're sending or receiving data the location of the simulation in three-dimensional space is done by triangulation with frequency receiving/sending devices. By changing the amplitudes and phase angles of the sound waves reaching the user's left and right ears, the device can effectively emulate the position of the sound source. The sounds reaching the ears will need to be isolated to avoid interference. The isolation can be accomplished by the use of earphones or the like.

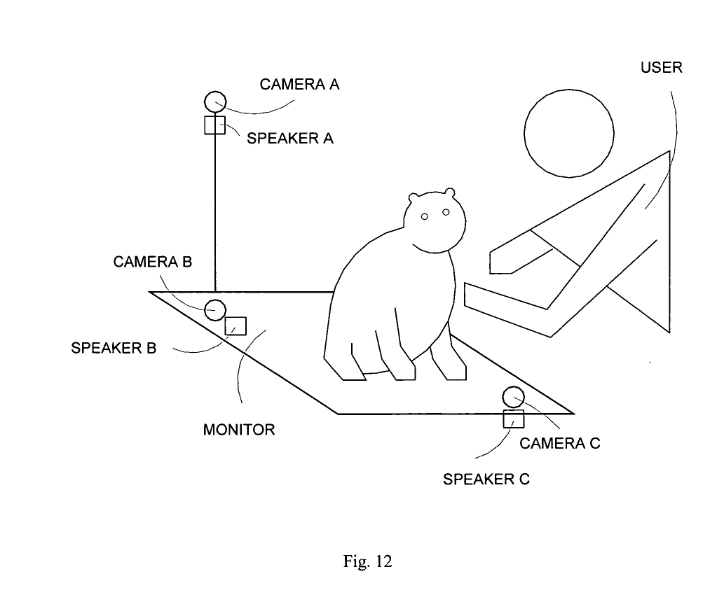

FIG. 12 shows an end-user looking at an image of a bear cub. Since the cub appears in open space above the viewing surface the end-user can reach in and manipulate the cub by hand or with a handheld tool. It is also possible for the end-user to view the cub from different angles, as they would in real life. This is accomplished though the use of triangulation where the three real-world cameras continuously send images from their unique angle of view to the computer. This camera data of the real world enables the computer to locate, track, and map the end-user's body and other real-world simulations positioned within and around the computer monitor's viewing surface.

FIG. 12 also shows the end-user viewing and interacting with the bear cub, but it includes 3D sounds emanating from the cub's mouth. To accomplish this level of audio quality requires physically combining each of the three cameras with a separate speaker. The cameras' data enables the computer to use triangulation in order to locate, track, and map the end-user's “left and right ear”. And since the computer is generating the bear cub, it knows the exact location of the cub's mouth. By knowing the exact location of the end-user's ears and the cub's mouth the computer uses triangulation to sends data, by modifying the spatial characteristics of the audio, making it appear that 3D sound is emanating from the cub's computer-generated mouth. Note that other sensors and/or transducers may be used as well.

Triangulation works by separating and positioning each camera/speaker device such that their individual frequency receiving/sending volumes overlap and cover the exact same area of space. If you have three widely spaced frequency receiving/sending volumes covering the exact same area of space than any simulation within the space can accurately be located.

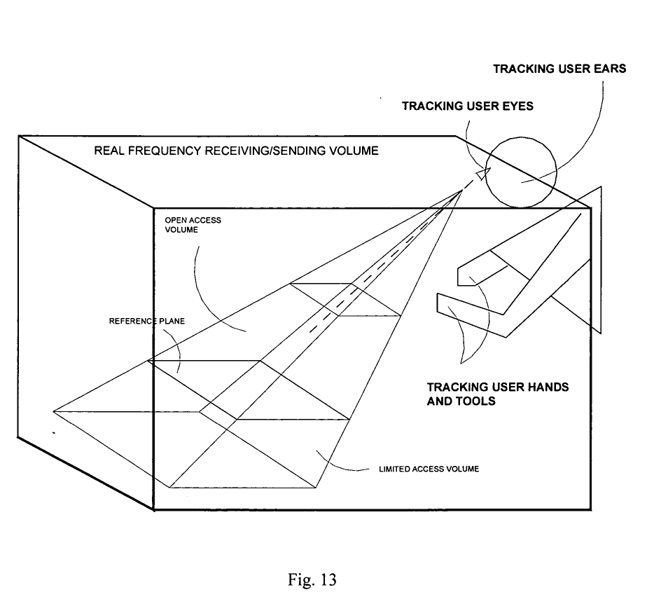

As shown in FIG. 13, the simulator then performs simulation recognition by continuously locating and tracking the end-user's “left and right eye” and their “line-of-sight”, continuously map the real-world left and right eye coordinates precisely where they are in real space, and continuously adjust the computer-generated cameras coordinates to match the real-world eye coordinates that are being located, tracked, and mapped. This enables the real-time generation of simulations based on the exact location of the end-user's left and right eye. It also allows the end-user to freely move their head and look around the images without distortion.

The simulator then perform simulation recognition by continuously locating and tracking the end-user's “left and right ear” and their “line-of-hearing”, continuously map the real-world left- and right-ear coordinates precisely where they are in real space, and continuously adjust the 3D Audio coordinates to match the real-world ear coordinates that are being located, tracked, and mapped. This enables the real-time generation of sounds based on the exact location of the end-user's left and right ears. It also allows the end-user to freely move their head and still hear sounds emanating from their correct location.

The simulator then perform simulation recognition by continuously locating and tracking the end-user's “left and right hand” and their “digits,” i.e. fingers and thumbs, continuously map the real-world left and right hand coordinates precisely where they are in real space, and continuously adjust the coordinates to match the real-world hand coordinates that are being located, tracked, and mapped. This enables the real-time generation of simulations based on the exact location of the end-user's left and right hands, allowing the end-user to freely interact with simulations.

The simulator then perform simulation recognition by continuously locating and tracking “handheld tools”, continuously map these real-world handheld tool coordinates precisely where they are in real space, and continuously adjust the coordinates to match the real-world handheld tool coordinates that are being located, tracked, and mapped. This enables the real-time generation of simulations based on the exact location of the handheld tools, allowing the end-user to freely interact with simulations.

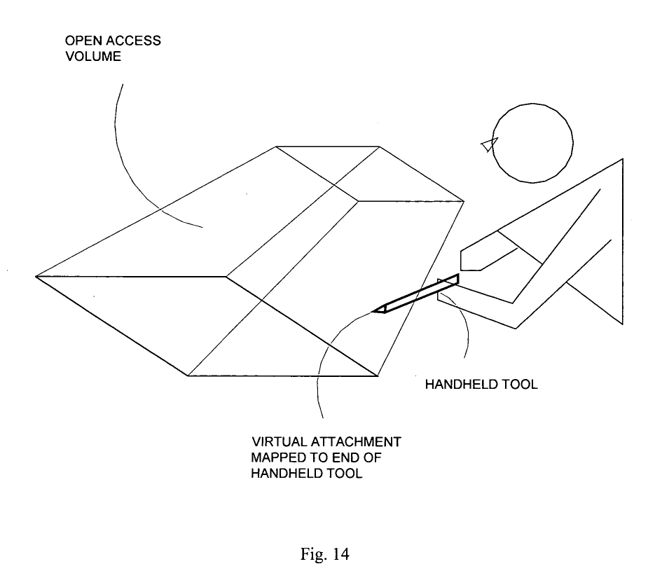

FIG. 14 is intended to assist in further explaining the handheld tools. The end-user can probe and manipulated the simulations by using a handheld tool, which in FIG. 14 looks like a pointing device.

A “computer-generated attachment” is mapped in the form of a computer-generated simulation onto the tip of a handheld tool, which in FIG. 14 appears to the end-user as a computer-generated “eraser”. The end-user can of course request that the computer maps any number of computer-generated attachments to a given handheld tool. For example, there can be different computer-generated attachments with unique visual and audio characteristics for cutting, pasting, welding, painting, smearing, pointing, grabbing, etc. And each of these computer-generated attachments would act and sound like the real device they are simulating when they are mapped to the tip of the end-user's handheld tool.

What is claim is:

1. A method of a 3D representation onto an open space to a user, comprising
providing a data set;
converting the data set into 3D horizontal perspective images to be displayed onto an open space using 3D horizontal perspective;
storing the 3D horizontal perspective images for fast display in a 3D horizontal perspective system.

2. A method as in claim 1 wherein the 3D horizontal perspective images are stereoscopic.

3. A method as in claim 1 wherein the data set is a computer file, a text file, a picture file, a drawing file, a measured file, or a database.

4. A method as in claim 1 wherein the data set represents raw data, information or knowledge.

5. A method of a 3D representation onto an open space to a user, comprising
providing a data set;
converting the data set into 3D horizontal perspective images to be displayed onto an open space using 3D horizontal perspective;
displaying the data set onto an open space using 3D horizontal perspective.

6. A method as in claim 5 wherein the 3D horizontal perspective images are stereoscopic.

7. A method as in claim 5 wherein the 3D horizontal perspective images are to be display on a substantially horizontal surface.

8. A method as in claim 5 wherein the 3D horizontal perspective images are to be displayed onto an open space to be touchable by hand or handheld tools.

9. A method as in claim 5 wherein the 3D horizontal perspective images are to be displayed for a single user.

10. A method as in claim 5 wherein the data set is a computer file, a text file, a picture file, a drawing file, a measured file, or a database.

11. A method as in claim 5 wherein the data set represents raw data, information, or knowledge.

12. A method of a 3D representation onto an open space to a user, comprising
providing a first data set;
displaying the first data set onto an open space by 3D horizontal perspective, the displayed image being a 3D horizontal perspective image;
allowing the user to touch the 3D horizontal perspective image;
selecting a second data set and display the second data set based on the touching action of the user.

13. A method as in claim 12 wherein the 3D horizontal perspective images are stereoscopic.

14. A method as in claim 12 wherein the 3D horizontal perspective images are to be display on a substantially horizontal surface.

15. A method as in claim 12 wherein the 3D horizontal perspective images are to be displayed onto an open space to be touchable by hand or handheld tools.

16. A method as in claim 12 further comprising a step of providing binaural audio.

17. A method as in claim 12 wherein the data set is a computer file, a text file, a picture file, a drawing file, a measured file, or a database.

18. A method as in claim 12 wherein the data set represents raw data, information, or knowledge.

19. A method as in claim 12 wherein the selection of the second data set is from an expert data for clarification of the first data set.

20. A method as in claim 12 wherein the selection of the second data set is resulted from calling an expert to transfer a data for clarification of the first data set.
